(19) United States
(12) Patent Application Publication
(10) Pub. No.: US 2017/0133008 A1
(43) Pub. Date: May 11, 2017

(54) METHOD AND APPARATUS FOR DETERMINING A RECOGNITION RATE

(71) Applicants: LE HOLDINGS (BEIJING) CO., LTD., Beijing (CN); LE SHI ZHI XIN ELECTRONIC TECHNOLOGY (TIAN JIN) LIMITED, Tianjin (CN)

(72) Inventor: Yujun WANG, Tianjin (CN)

(21) Appl. No.: 15/226,169

(22) Filed: Aug. 2, 2016

Related U.S. Application Data
(63) Continuation of application No. PCT/CN2016/082140, filed on May 13, 2016.

(30) Foreign Application Priority Data
Nov. 5, 2015 (CN) 201510744496.8

(51) Int. Cl. G10L 15/10; G10L 15/28; G10L 15/00

(52) U.S. Cl. CPC G10L 15/10; G10L 15/005; G10L 15/28

(57) ABSTRACT

Disclosed are a method and apparatus for determining a recognition rate, and the method can obtain a string of characters obtained by recognizing voice, and a standard recognition result corresponding to the string of characters, where the standard recognition result includes phonetic character type, and Chinese characters; divide the string of characters according to a character type in the string of characters to generate a sequence of characters, and divide the standard recognition result to generate a standard recognition result sequence: calculate the shortest edition distance between the sequence of characters, and the standard recognition result sequence; and determine a recognition rate of a voice recognition apparatus according to the calculated shortest edition distance.

### CROSS-REFERENCE TO RELATED APPLICATIONS

This application, is a continuation of International Application No. PCT/CN2016/082140, filed on May 13, 2016, which claims priority to Chinese Patent Application No. 201510744496.8, filed on Nov. 05, 2015, both of which are hereby incorporated by-reference in their entireties.

### TECHNICAL FIELD

The present disclosure relates to the field of data processing, and particularly to a method and apparatus for determining a recognition rate.

### BACKGROUND

The technology of voice recognition is a technology to convert by a machine a voice signal into a corresponding command or text by recognizing and interpreting it. At present, the technology of voice recognition is widely applied to voice manipulation, voice translation, and other voice interactive products.

At present, after a voice recognition system performs voice recognition on the voice signal in order to determine the performance of the voice recognition system, a voice recognition result is typically compared with a standard voice recognition result, and the recognition rate of recognizing the voice information by the voice recognition system is determined from a comparison result.

At present while the recognition rate of the voice recognition system is being determined, since a voice recognition apparatus recognizing voice in both Chinese and English may recognize English voice as Chinese characters, an existing voice recognition rate detecting apparatus needs to compare respective letters in recognized English words with respective letters in English words in the standard voice recognition result, where the letters are separate elements, so that the recognition rate may be detected by involving a much larger number of recognition errors, thus resulting in an inaccurately calculated recognition rate of the voice recognition apparatus.

As can be apparent, there is such a problem in the prior art that the voice recognition rate may be determined inaccurately.

### SUMMARY

Embodiments of the disclosure provide a method and apparatus for determining a recognition rate so as to address the problem in the prior art that the voice recognition rate may be determined inaccurately.

Particular technical solutions according to the embodiments of the disclosure are as follows:

Some embodiments of the disclosure provide a method for determining a recognition rate, the method includes:

obtaining a string of characters obtained by recognizing voice, and a standard recognition result corresponding to the voice, wherein the standard recognition result includes characters of a phonetic character type, and characters of a Chinese character type;

dividing the string of characters according to a character type in the string of characters to generate a sequence of characters, wherein when the string of characters includes phonetic characters, a number of phonetic characters representing one complete meaning is divided into a recognition element;

calculating a shortest edition distance between the sequence of characters, and a standard recognition result sequence generated by dividing the standard recognition result;

obtaining an optimum alignment result between the sequence of characters and the standard recognition result sequence according to a calculated shortest edition distance;

determining a recognition rate of the sequence of characters with respect to the standard recognition result sequence according to the optimum alignment result between the sequence of characters and the standard recognition, result sequence, wherein the recognition rate includes a recognition error rate of phonetic characters, and a recognition error rate of Chinese characters.

Some embodiments of the disclosure provide an electronic device, the electronic device includes:

at least one processor; and

a memory communicably connected with the at least one processor for storing instructions executable by the at least one processor, wherein execution of the instructions by the at least one processor causes the at least one processor to:

obtain a string of characters obtained by recognizing voice, and a standard recognition result corresponding to the voice, wherein the standard recognition result includes characters of a phonetic character type, and characters of a Chinese character type;

divide the string of characters according to a character type in the string of characters to generate a sequence of characters, wherein when the string of characters includes phonetic characters, then a number of phonetic characters representing one complete meaning is divided into a recognition element;

calculate a shortest edition distance between the sequence of characters, and a standard recognition result sequence generated by dividing the standard recognition result;

obtain an optimum alignment result between the sequence of characters and the standard recognition result sequence according to a calculated shortest edition distance;

determine a recognition rate of the sequence of characters with respect to the standard recognition result sequence according to the optimum alignment result between the sequence of characters and the standard recognition result sequence, wherein the recognition rate includes a recognition error rate of phonetic characters, and a recognition error rate of Chinese characters.

Some embodiments of the disclosure provide a non-transitory computer-readable storage medium storing executable instructions that, when executed by an electronic device, cause the electronic device to:

obtain a string of characters obtained by recognizing voice, and a standard recognition result corresponding to the string of characters, wherein the standard recognition result comprises characters of phonetic character type, and characters of Chinese character type;

divide the string of characters according to a character type in the siring of characters to generate a sequence of characters, wherein when the string of characters comprises phonetic character, a number of phonetic characters representing one complete meaning is divided into a recognition element;

calculate a shortest edition distance between the sequence of characters, and a standard recognition result sequence generated by dividing the standard recognition result;

obtain an optimum alignment result between the sequence of characters and the standard recognition result sequence according to the calculated shortest edition distance; and

determine a recognition rate of the sequence of characters with respect to the standard recognition result sequence according to the optimum alignment result between the sequence of characters and the standard recognition result sequence, wherein the recognition rate comprises a recognition error rate of phonetic characters, and a recognition error rate of Chinese characters.

In some embodiments of the disclosure, an apparatus for determining a recognition rate can obtain a string of characters obtained by recognizing voice, and a standard recognition result corresponding to the string of characters, where the standard recognition result includes characters of she phonetic character type, and characters of the Chinese character type; divide the string of characters according to a character type in the string of characters to generate a sequence of characters, and divide the standard recognition result according to a character type in the standard recognition result to generate a standard recognition result sequence; where when the string of characters includes phonetic characters, a number of phonetic characters representing one complete meaning is divided into a recognition element; calculate the shortest edition distance between the sequence of characters, and the standard recognition result sequence; and determine a recognition rate of a voice recognition apparatus according to the calculated shortest edition distance. With the technical solutions according to the embodiments of the disclosure, if the phonetic character are English characters, then the Chinese characters (and digits), and the English words in the string of characters obtained as a result of recognition and the standard recognition result are determined as evaluation elements, the shortest edition distance is calculated, and then the optimum set of alignment correspondence relationships for the string of characters and the standard recognition result is generated through backtracking, so that the error rate of Chinese characters and digits, the error rate of English words, and the total error rate can be calculated respectively, where an English word can be treated as a whole to thereby avoid the error rate from being calculated incorrectly at a higher probability if each character in the word is regarded as an element, thus improving the accuracy of the calculated error rate.

### BRIEF DESCRIPTION OF THE DRAWINGS

disclosure One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic architectural diagram of a voice recognition system according to some embodiments of the disclosure;

FIG. 2 is a flow chart of determining a recognition rate according to some embodiments of the disclosure;

FIG. 3 is a flow chart of calculating the shortest, edition distance according to some embodiments of the disclosure;

FIG. 4 is a schematic diagram of a two-dimension grid according to some embodiments of the disclosure;

FIG. 5 is a correspondence table of an error type to a backtracking pointer according to some embodiments of the disclosure;

FIG. 6 is a flow chart of determining a recognition rate according to some embodiments of the disclosure;

FIG. 7 is a schematic diagram of a set of alignment relationships according to some embodiments of the disclosure;

FIG. 8 is a schematic structural diagram of an apparatus for determining a recognition rate according to some embodiments of the disclosure; and

FIG. 9 is a schematic structural diagram of an electronic device according to some embodiments of the disclosure.

### DETAILED DESCRIPTION

In order to make the technical solutions according to some embodiments of the disclosure or in the prior art more apparent, the drawings to which a description of the embodiments or the prior art refers will be briefly introduced below, and apparently the drawings to be described below are merely illustrative of some of the embodiments of the disclosure, and those ordinarily skilled in the art can derive from these drawings other drawings without any inventive effort. In the drawings:

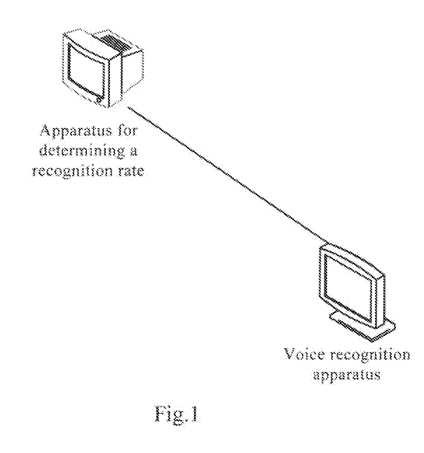

Referring to FIG. 1 illustrating a schematic architectural diagram of a system for determining a voice recognition rate according to some embodiments of the disclosure, the system for determining a voice recognition rate includes a voice recognition apparatus and a recognition rate determining apparatus, where the voice recognition apparatus is configured to recognize voice information to obtain a string of characters as a result of recognition, and preferably the voice information is voice information of training samples, that is, the result of recognizing the voice information is a known standard recognition result; and moreover the voice recognition apparatus can recognize Chinese characters, and characters in a language corresponding to phonetic characters, where the language corresponding to phonetic characters is a language in which a number of characters represent together a complete word, e.g., English, French, etc., and the recognition rate determining apparatus is configured to obtain the string of characters obtained by the voice recognition apparatus as a result of recognition, and to compare the string of characters with the standard recognition result to thereby determine a recognition rate of recognizing the voice information by the voice recognition apparatus.

The embodiment of the disclosure will be described below in further details with reference to the drawings.

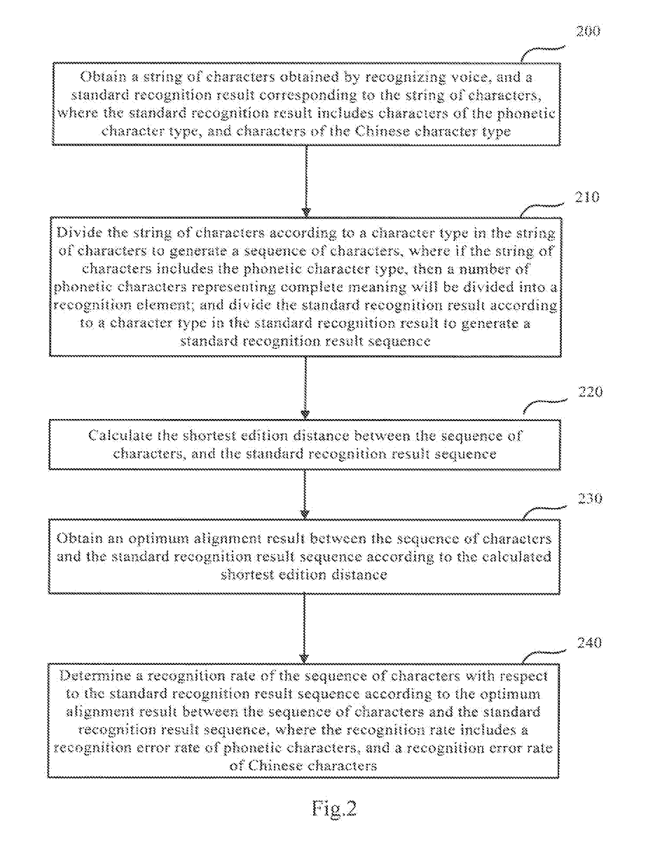

Referring to FIG. 2, a process in which the apparatus for determining a recognition rate obtains the voice recognition sate according to embodiments of the disclosure includes the following steps:

The step 200 is to obtain a string of characters obtained by recognizing voice, and a standard recognition result corresponding to the voice, where the standard recognition result includes characters of the phonetic character type, and characters of the Chinese character type.

In some embodiments of the disclosure, the apparatus for determining a recognition rate obtains the string of characters obtained by the voice recognition apparatus, and the standard recognition result corresponding to the string of characters, where the standard recognition result includes characters of at least two character types, i.e., the phonetic character type and the Chinese character type.

The step 210 is to divide the string of characters according to a character type In the string of characters to generate a sequence of characters, where when the string of characters includes the phonetic character type, a number of phonetic characters representing complete meaning is divided into a recognition element.

In some embodiments of the disclosure, the apparatus for determining a recognition rate divides the string of characters obtained as a result of recognition, and the corresponding standard recognition result respectively after obtaining the string of characters, and the standard recognition result, to thereby obtain the sequence of characters generated by dividing the string of characters, and the standard recognition result sequence generated by dividing the standard recognition result respectively.

Optionally after the apparatus for determining a recognition rate can further normalize the string of characters and the standard recognition result after obtaining the string of characters and the standard recognition result, and before dividing the string of characters, to thereby improve the accuracy of the resulting recognition rate.

Particularly the apparatus for determining a recognition rate normalizes the string of characters by eliminating punctuations in the string of characters; for any one Chinese character in the string of characters, if the any one Chinese character represents a digit, then converting the any one Chinese character into a corresponding American Standard Code for information Interchange (ASCII) code character; and converting phonetic characters in the string of characters into corresponding ASCII code characters;

Furthermore the apparatus for determining a recognition rate normalizes the standard recognition result under the same rule as the string of characters by eliminating punctuations in the standard recognition result; for any one Chinese character in the standard recognition result, if the any one Chinese character represents a digit, then converting the any one Chinese character into a corresponding ASCII code character; and converting phonetic characters in the standard recognition result into corresponding ASCII code characters.

With the technical solution, the apparatus for determining a recognition rate normalizes the string of characters and the standard recognition result by eliminating the punctuations in the string of characters and the standard recognition result to thereby avoid the punctuations from interfering with the recognition result so as to improve the accuracy of the recognition rate, and processes the characters in the string of characters and the standard recognition result so that all the characters are formatted uniformly to thereby avoid such a problem that since some character in the string of characters is not consistent with some character in the standard recognition result while recognizing the character, the apparatus for determining a recognition rate may misjudge that the character is recognized incorrectly, so as to improve the accuracy of the recognition rate.

Furthermore since the string of characters and the standard recognition result may include a specific symbol which is the Space symbol or the Tab symbol, for this, the apparatus for determining a recognition rate respectively normalizing the string of characters and the standard recognition result further includes: if the string of characters or the standard recognition result includes a specific symbol, then if the specific character is adjacent to a Chinese character, or the specific symbol is located between a Chinese character and a phonetic character, then deleting the specific symbol or if the specific symbol is located between phonetic characters, or the specific symbol is located between a phonetic character and a digit, then reserving the specific symbol. For example, taking the string of characters as ah example, the string of characters is “iPhone6 plus, [symbol] ”, the string of characters is normalized by deleting“, ” after “plus”, and the Space symbol between “ [symbol] ” and “ [symbol] ”, and since “plus” is a phonetic character, and “6” is a digit, the Space symbol between “6” and “plus” is reserved: and in another example, if the string of characters is “I love you”, then since all of “I”, “love”, and “you” are phonetic characters, the Space symbols among these three words are reserved.

With this solution, the specific character in the string of characters and the standard recognition result can be eliminated to thereby avoid the specific character from being processed as a separate characters when the string of characters and the standard recognition result are subsequently divided, which would otherwise involve a large number of recognition errors of the voice recognition apparatus identified as a result, thus discoursing the recognition rate of the voice recognition apparatus from being determined accurately.

In some embodiments of the disclosure, the apparatus for determining a recognition rate divides the normalized string of characters to generate the sequence of characters including a number of characters.

Particularly for any one character in the normalized string of characters, if the character type of the any one character is the Chinese character type, then the any one character will be determined jus a recognition element; and if the any one character is a phonetic character, then if the any one character is located between two Space symbols, then the any one character will be determined as a recognition element, otherwise, the closest two Space symbols to the any one character will be located respectively, and all the characters between the located two Space symbols will be determined as a recognition element; the respective determined recognition elements are sorted according to the positions of the determined recognition elements in the normalized string of characters; and the sorted recognition elements are determined as the sequence of characters. For example, if the string of characters is “I love you [symbol] ”, where “I” is a phonetic character, then the apparatus for determining a recognition rate will determine the character “I” as a first character in the string of characters, and since the next position to the character “I” is the Space symbol, the character “I” is a recognition element; all the characters “I”, “o”, “v”, and “e” are phonetic characters, and since “love” is located between two Space symbols, “love” is a recognition element, and alike “you” is also a recognition element; since all the characters “ [symbol] ”, “ [symbol] ”, “ [symbol] ”, “ [symbol] ”, “ [symbol] ”, “ [symbol] ”, and “ [symbol] ” are Chinese characters “ [symbol] ” is a recognition element, “ [symbol] ” is a recognition element, “ [symbol] ” is a recognition element, “ [symbol] ” is a recognition element, “ [symbol] ” is a recognition clement, “ [symbol] ” is a recognition element, and “ [symbol] ” is a recognition element, so the resulting sequence of characters is “I”, “love”, “you”, “ [symbol] ”, “ [symbol] ”, “ [symbol] ”, “ [symbol] ”, “ [symbol] ”, “ [symbol] ”, “ [symbol] ”.

Furthermore the apparatus for determining a recognition rate divides the normalized standard recognition result to generate the standard recognition result sequence.

Particularly for any one character in the normalized standard recognition result, if the character type of the any one character is the Chinese character type, then the any one character will be determined as a standard element; and if the any one character is a phonetic character, then if the any one character is located between two Space symbols, then the any one character will be determined as a standard element, otherwise, the closest two Space symbols to the any one character will be located respectively, and all the characters between the located two Space symbols will be determined as a standard element; the respective determined standard elements are sorted according to the positions of the determined standard elements in the normalized standard recognition result; and the sorted standard elements are determined as the sequence of characters.

As compared with the prior art in which phonetic characters are not distinguished from Chinese characters, but each phonetic character is recognized as an element, thus resulting in an inaccurate recognition rate, with the technical solution, the string of characters and the standard recognition result can be divided according to the character types of the character in the string of characters, and the character types of the characters in the standard recognition result, so that a Chinese character is determined as an element, and a number of phonetic characters representing complete meaning are determined as an element to thereby avoid the apparatus for determining a recognition rate from mistaking a recognition error of the voice recognition apparatus on a word for a number of recognition errors of the voice recognition apparatus on respective letters in the word, so as to improve the accuracy of the recognition rate.

The step 220 is to calculate the shortest edition distance between the sequence of characters, and the standard recognition result sequence generated by dividing the standard recognition result.

In some embodiments of the disclosure, the apparatus for determining a recognition rate calculates for the generated sequence of characters and standard recognition result sequence the shortest edition distance between the sequence of characters and standard recognition result sequence, and determines the difference between the string of characters and the standard recognition result based upon the shortest edition distance.

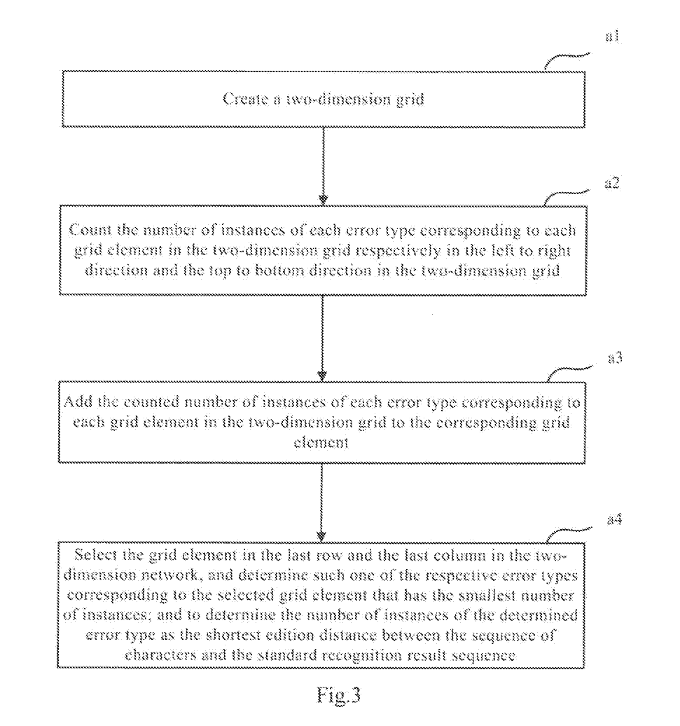

Optionally referring to FIG. 3, the apparatus for determining a recognition rate calculates the shortest edition distance between the sequence of characters and standard recognition result sequence particularly in the following steps:

The step a1 is to create a two-dimension grid.

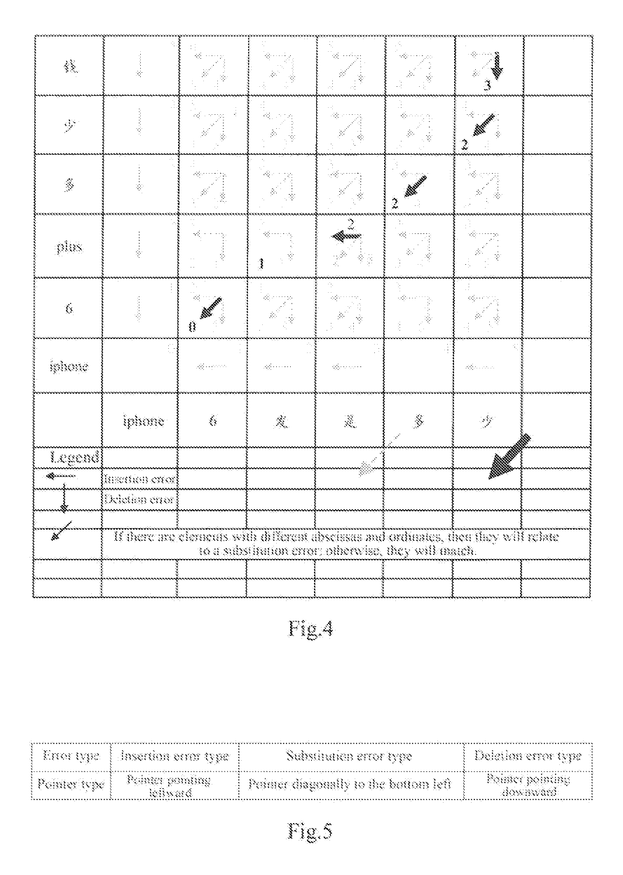

Referring to FIG. 4, a first dimension of the two-dimension grid represents the recognition elements in the sequence of characters, and a second dimension of the two-dimension grid represents the standard elements in the standard recognition result sequence; and the number of grid elements in the first dimension is equal to the number of recognition elements in the sequence of characters, and the number of grid elements in the second dimension is equal to the number of standard elements in the standard recognition result sequence, where each of the recognition elements corresponds to a grid element in the first dimension, and each of the standard elements corresponds to a grid element in the second grid.

Referring to FIG. 4, for example, taking as an example the standard recognition result sequence of “iPhone”, “6”, “plus”, “ [symbol] ”, “ [symbol] ”, “ [symbol] ”, “ [symbol] ”, and the sequence of characters of “iPhone”, “6”, “ [symbol] ”,“ [symbol] ”, “ [symbol] ”, “ [symbol] ”, the first dimension is the horizontal dimension on which there are 6 grid elements, and the second dimension is the vertical dimension on which there are 6 grid elements; recognition elements are filled sequentially into positions corresponding to their positions in the sequence of characters, in the left to right direction on the first dimension, that is, “iPhone” is filled into the position corresponding to the first grid element, “6” is filled into the position corresponding to the second grid element, “ [symbol] ” is filled into the position corresponding to the third grid element, “ [symbol] ”is filled into the position corresponding to the fourth grid element “ [symbol] ” is filled into the position corresponding to the fifth grid element, and “ [symbol] ” is filled into the position corresponding to the sixth grid element, in the left to right direction; and alike, standard elements are filled sequentially into positions corresponding to their positions in the standard recognition result, sequence, in the bottom to top direction, on the second dimension, that is, “iPhone” is filled into the position corresponding to the first grid element, is filled into the position corresponding to the second grid element, “plus” is filled into the position corresponding to the third grid element, “ [symbol] ” is filled Into the position corresponding to the fourth grid element, “ [symbol] ” is filled into the position corresponding to the fifth grid element, and “ [symbol] ” is filled into the position corresponding to the sixth grid element, in the bottom to top direction,

The step a2 is to count the number of instances of each error type corresponding to each grid element in the two-dimension grid respectively in the left to right direction and the top to bottom direction in the two-dimension grid.

The number of instances of each error type is the sum of the number of instances of the error type in a preceding grid element corresponding to the error type, and the number of instances of the error type of the recognition element corresponding to the grid element with respect to the standard element; and the error type includes an insertion error type, a substitution error type, and a deletion error type. Additionally the preceding grid element corresponding to the error type is a grid element, adjacent to the current grid element to which a backtracking pointer corresponding to the error type points.

Optionally the number of instances of the error type of the recognition element corresponding to the grid element with respect to the standard element can be counted by creating a training module in the apparatus for determining a recognition rate.

Optionally a corresponding backtracking pointer is set for each error type in the two-dimension grid: and referring to FIG. 5, for example, a reference table in the form of a corresponding backtracking pointer is set for each error type, where the backtracking pointer corresponding to the insertion error type is a pointer pointing leftward, the backtracking pointer corresponding to the substitution error type is a pointer pointing diagonally to the bottom left of the grid element in the two-dimension grid, and the backtracking pointer corresponding to the deletion error type is a pointer pointing downward.

Based upon the backtracking pointer, if the error type is the insertion error type, then the following operations will be performed for each grid element the number of instances of the insertion error type corresponding to the grid element is counter, and the number of instances of the insertion error type of the recognition element corresponding to the grid element with respect to the standard element (a first number below) is counted, where the first number is 1 or 0; a preceding grid element to the grid element is determined as an adjacent grid element to the grid element and located to the left of the grid element (a left-adjacent grid element below) according to the backtracking pointer corresponding to the insertion error type, which is a pointer pointing leftward; the number of instances of the insertion error type of the left-adjacent grid element (a second number below) is counted; and the sum of the first number and the second number is calculated as the number of instances of the insertion error type corresponding to the grid element. Referring to FIG. 4, for example, the recognition element corresponding to the grid element in the third row and the fourth column is denoted as “ [symbol] ”, and the standard element corresponding to the grid element is “plus”, so the number of instances of the insertion error type of the recognition element with respect to the standard element is 1, and the number of instances of the insertion error type corresponding to the left-adjacent grid element (in the third row and the third column) is 1, so the number of instances of the insertion error type corresponding to the grid element in the third row and the fourth column is 2 (i.e., 1+1).

Correspondingly If the error type is the substitution error type, then the following operations will be performed for each grid element: the number of instances of the substitution error type corresponding to the grid element is counted, and the number of instances of the substitution error type of the recognition element corresponding to the grid element with respect to the standard element (a third number below) is counted, where the first number is 1 or 0; a preceding grid element to the grid element is determined as an adjacent grid element to the grid element and located diagonally on the bottom left of the grid element (a diagonally adjacent grid element below) according to the backtracking pointer corresponding to the substitution error type, which is a pointer pointing diagonally to the bottom left; the number of instances of the substitution error type of the diagonally adjacent grid element (a fourth number below) is counted; and the sum of the third number and the fourth number is calculated as the number of instances of the insertion error type corresponding to the grid element. Referring to FIG. 4, for example, the recognition element corresponding to the grid element in the third row and the fourth column is denoted as “ [symbol] ”, and the standard element corresponding to the grid element is “plus”, so the number of instances of the substitution error type of the recognition element with respect to the standard element is 1, and the number of instances of the substitution error type corresponding to the diagonally adjacent grid element (in the second row and the third column) is 1, so the number of instances of the substitution error type corresponding to the grid element in the third row and the fourth column is 2 (i.e., 1+1).

Correspondingly if the error type is the deletion error type, then the following operations will be performed for each grid element: the number of instances of the deletion error type corresponding to the grid element is counted, and the number of instances of the deletion error type of the recognition element corresponding to the grid element with respect to the standard element (a fifth number below) is counted, where the first number is 1 or 0; a preceding grid element to the grid element is determined as an adjacent grid element to the grid element and located below the grid element (a below-adjacent grid element below) according to the backtracking pointer corresponding to the deletion error type, which is a pointer pointing downward; the number of instances of the deletion error type of the below-adjacent grid element (a sixth number below) is counted; and the sum of the fifth number and the sixth number is calculated as the number of instances of the deletion error type corresponding to the grid element. Referring to FIG. 4, for example, the recognition element corresponding to the grid element in the third row and the fourth column is denoted as “ [symbol] ”, and the standard element corresponding to the grid element is “plus”, so the number of instances of the deletion error type of the recognition element with respect to the standard element is 1, and the number of instances of the deletion error type corresponding to the below-adjacent grid element (in the second row and the fourth column) is 2, so the number of instances of the deletion error type corresponding to the grid element in the third row and the fourth column is 3 (i.e., 1+2).

The step a3 is to add the counted number of instances of each error type corresponding to each grid element in the two-dimension grid to the corresponding grid element.

The step a4 is to select the grid element in the last row and the last column in the two-dimension network, and to determine such one of the respective error types corresponding to the selected grid element that has the smallest number of instances; and to determine the number of instances of the determined error type as the shortest edition distance between the sequence of characters and the standard recognition result sequence.

In some embodiments of the disclosure, referring to FIG. 4, the grid element in the last row and the last column (i.e., the sixth row and the sixth column) in the two-dimension grid is selected, and the number of instances of the insertion error type, the number of instances of the substitution error type, and the number of instances of the deletion error type in the grid element in the last row and the last column are counted, so that the apparatus for determining a recognition rate selects the error type with the smallest one of the number of instances of the insertion error type, the number of instances of the substitution error type, and the number of instances of the deletion error type, and determines the selected error type with the smallest number of instances as the shortest edition distance between the sequence of characters and the standard recognition result sequence.

Optionally if the number of error types is regarded as a punishment, then the shortest edition distance can be determined in the following logic relationship:

Accumulated punishment (0,0)=0; // The optimum accumulated punishment of the grid element on the bottom left

For i=1:N−1 //N represents the length of the standard recognition result sequence

Accumulated punishment (i,0)=Accumulated punishment i−1,0)+Deletion punishment

For i=1:M−1 //M represents the length, of the sequence of characters

Accumulated punishment (0,i)=Accumulated punishment (0,i−1)+Insertion punishment

For i=1, N−1
For j=1; M−1
   If (Backtracking pointer points leftward)
      Left-accumulated punishment (i,j)=Accumulated punishment (i,j−1)+Insertion punishment;
   If (Backtracking pointer points diagonal line)
      If (standard element(i)!=recognition element(i)
         Diagonally accumulated punishment (i,j)=Accumulated punishment (i−1, j−1)+Substitution punishment
   If (Backtracking pointer points downward)
      Below-accumulated punishment (i,j)=Accumulated punishment (i−1,j)+Deletion punishment;

Accumulated punishment (i,j)=

Min (Left-accumulated punishment (i,j), Diagonally accumulated punishment (i,j), Below-accumulated punishment (i,j));
Backtracking pointer=argmin_{Φ[Left, Diagonally, Below](ΦAccumulated punishment(i,j))};

Shortest edition distance=Accumulated punishment (N−1, M−1)

The step 230 is to obtain an optimum alignment result between the sequence of characters and the standard recognition result sequence according to the calculated shortest edition distance.

In some embodiments of the disclosure, the apparatus for determining a recognition rate obtains the backtracking pointer corresponding to the shortest edition distance, and the backtracking pointer corresponding to each grid element according to the calculated shortest edition distance, and determines the optimum alignment result between the sequence of characters and the standard recognition result sequence according to the obtained backtracking pointers.

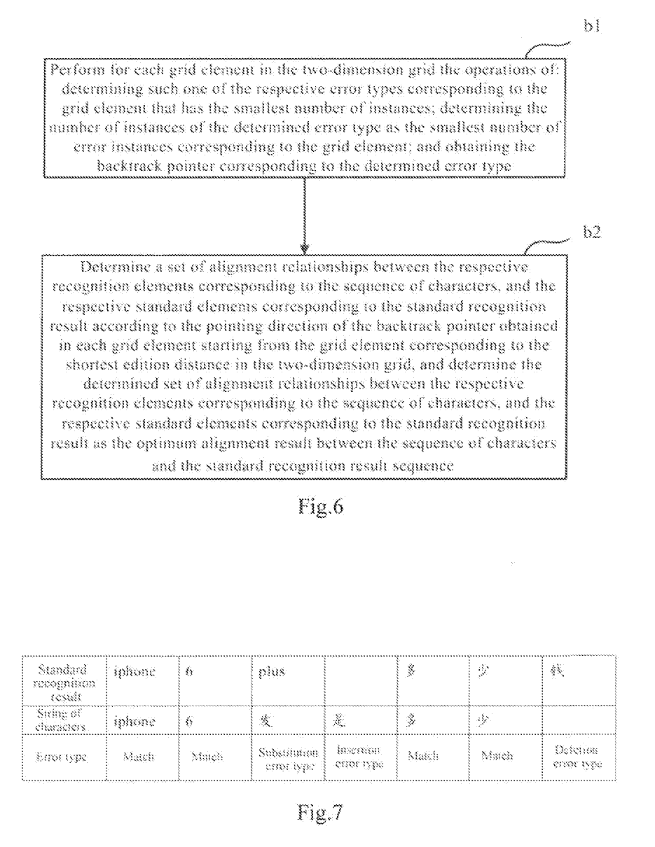

Optionally, referring to FIG. 6, the apparatus for determining a recognition rate determines the optimum alignment result between the sequence of characters and the standard recognition result sequence as follows:

The step b1 is to perform for each grid element in the two-dimension grid the operations of: determining such one of the respective error types corresponding to the grid element that has the smallest number of instances; determining the number of instances of the determined error type as the smallest number of error instances corresponding to the grid element: and obtaining the backtracking pointer corresponding to the determined error type.

In some embodiments of the disclosure, referring to FIG. 4, the same operations are performed for each grid element in the two-dimension network, that is, such one of the respective error types corresponding to the grid element that has the smallest number of instances is determined, that is, such one of the respective error types of the grid element in the sixth row and the sixth column that has the smallest number of instances is the deletion error type as illustrated in FIG. 4, and the backtracking pointer corresponding to the deletion error type is a pointer pointing downward.

Furthermore if there are such two of the respective error types corresponding to any one grid element that have the identical smallest numbers of instances, then the apparatus for determining a recognition rate will select either of the error types with the identical smallest numbers of instances, and obtain the backtracking pointer corresponding to the selected error type. For example, such two of the respective error types corresponding to the grid element in the third row and the fourth column that have the identical smallest numbers of instances are the insertion error type and the substitution error type, so that the apparatus for determining a recognition rate can select the insertion error type, and obtain the backtracking pointer corresponding to the insertion error type; or the apparatus for determining a recognition rate can select the substitution error type, and obtain the backtracking pointer corresponding to the substitution error type.

The step b2 is to determine a set of alignment relationships between the respective recognition elements corresponding to the sequence of characters, and the respective standard elements corresponding to the standard recognition result according to the pointing direction of the backtracking pointer obtained in each grid element starting from the grid element corresponding to the shortest edition distance in the two-dimension grid, and to determine the determined set of alignment relationships between the respective recognition elements corresponding to the sequence of characters, and the respective standard elements corresponding to the standard recognition result as the optimum alignment result between the sequence of characters and the standard recognition result sequence.

In some embodiments of the disclosure, since each grid element corresponds respective one of the elements in the sequence of characters, and respective one of the elements in the standard recognition result sequence, it can be determined from the obtained backtracking pointer whether the element in the sequence characters corresponding to the grid element is the same as the element in the standard recognition result sequence corresponding to the grid element, and if the element in the sequence characters corresponding to any one grid element is not the same as the element in the standard recognition result sequence corresponding to the any one grid element then an error type of the element in the sequence characters corresponding to the any one grid element with respect to the element in the standard recognition result sequence corresponding to the any one grid element will be determined.

Referring to FIG. 7, for example, in some embodiments of the disclosure, there are a standard element and a recognition element in each correspondence relationship in the set of correspondence relationships generated from FIG. 4.

With the technical solution above, error types of each recognition element with respect to each standard element, and the accumulated number of instances of each error type are determined in the two-dimension network; and a correspondence relationship between each standard element in the standard recognition result sequence, and the recognition element in the sequence of characters is determined for the error type with the smallest number of instances in each grid element in the two-dimension table, and a more accurate optimum set of correspondence relationships is obtained through optimum backtrack alignment to thereby facilitate a subsequent statistic of the rate of voice recognition errors so as to guarantee the accuracy of the resulting rate of voice recognition errors.

The step 240 is to determine a recognition rate of the sequence of characters with respect to the standard recognition result sequence according to the optimum alignment result between the sequence of characters and the standard recognition result sequence, where the recognition rate includes a recognition error rate of phonetic characters, and a recognition error rate of Chinese characters.

In some embodiments of the disclosure, the apparatus for determining a recognition rate determines the recognition rate of the sequence of characters with respect to the standard recognition result sequence according to the number of instances of the error type corresponding to each alignment relationship in the set of alignment relationships, where the recognition rate includes a recognition error rate of phonetic characters, and a recognition error rate of Chinese characters.

Optionally the apparatus for determining a recognition rate determines the recognition error rate of Chinese characters by selecting a correspondence relationship of Chinese characters in the set of alignment relationships, where the correspondence relationship of Chinese characters includes standard elements of Chinese characters; and calculating the rate of the number of correspondence relationships of all the recognition errors in the selected correspondence relationship to the total number of standard elements of Chinese characters as the recognition error rate of Chinese characters of the sequence of characters with respect to the standard recognition result sequence. Referring to FIG. 7, for example, the correspondence relationship of recognition errors of phonetic characters includes “ [symbol] ” and the Space symbol, and the total number of standard elements of Chinese characters is 4, so the rate of recognition errors of Chinese characters is 25% (¼).

Optionally the apparatus for determining a recognition rate determines the recognition rate of phonetic characters by selecting a correspondence relationship of phonetic characters in the set of alignment relationships, where the correspondence relationship of phonetic characters includes standard elements of phonetic characters; and calculating the rate of the number of error types of correspondence relationships of all the recognition errors in the selected correspondence relationship to the total number of standard elements of phonetic characters as the recognition rate of phonetic characters of the sequence of characters with respect to the standard recognition result sequence. Referring to FIG. 7, for example, the correspondence relationship of recognition errors of phonetic characters includes “ [symbol] ” and “ [symbol] ” and “plus”, and the total number of standard elements of phonetic characters is 2, so the rate of recognition errors of phonetic characters is 100% (2/2).

Furthermore the apparatus for determining a recognition rate can determine the total recognition rate from the recognition rate of phonetic characters, and the recognition rate of type in the set of alignment relationships; counting the total number of instances of the respective error types in the set of correspondence relationships; and calculating the rate of the total number of instances of the error type to the total number of instances of the respective error types as the rate of error type for the error type.

With the technical solutions according to the embodiments of the disclosure, the Chinese characters (and digits), and the phonetic words in the string of characters and the standard recognition result obtained as a result of recognition are determined as evaluation elements, the shortest edition distance is calculated, and the optimum set of alignment correspondence relationships for the string of characters and the standard recognition result is generated through backtracking, so that the error rate of Chinese characters and digits, the error rate of phonetic characters, and the total error rate can be calculated respectively, where a phonetic word can he treated as a whole to thereby avoid the error rate from being calculated incorrectly at a higher probability if each character in the word is regarded as an element, thus improving the accuracy of the calculated error rate.

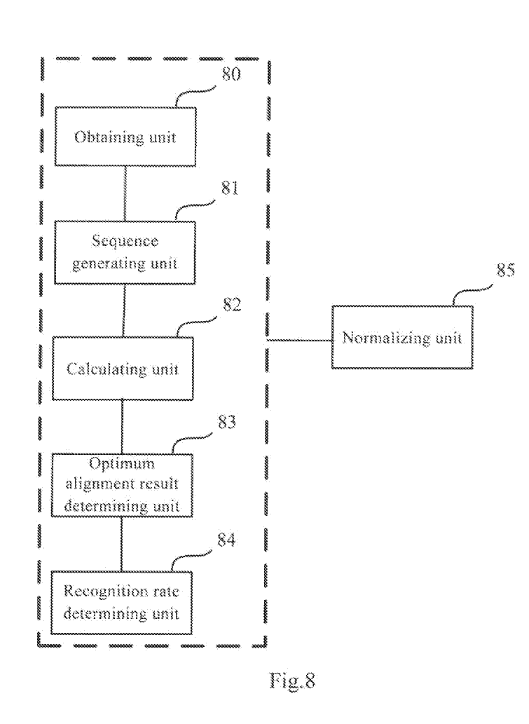

Further to the technical solution above, referring to FIG. 8, some embodiments of the disclosure further provide an apparatus for determining a recognition rate, which includes an obtaining unit 80, a sequence generating unit 81, a calculating unit 82, an optimum alignment result determining unit 83, and a recognition rate determining unit 84, where:

The obtaining unit 80 is configured to obtain a string of characters obtained by recognizing voice, and a standard recognition result corresponding to the string of characters, where the standard recognition result includes characters of the phonetic character type, and characters of the Chinese character type;

The sequence generating unit 81 is configured to divide the string of characters according to a character type in the string of characters to generate a sequence of characters, where when the string of characters includes phonetic character, a number of phonetic characters representing one complete meaning is divided into a recognition element;

The calculating unit 82 is configured to calculate the shortest edition distance between the sequence of characters, and the standard recognition result sequence generated by dividing the standard recognition result;

The optimum alignment result determining unit 83 is configured to obtain an optimum alignment result between the sequence of characters and the standard recognition result sequence according to the calculated shortest edition distance; and

The recognition rate determining unit 84 is configured to determine a recognition rate of the sequence of characters with respect to the standard recognition result sequence according to the optimum alignment result between the sequence of characters and the standard recognition result sequence, where the recognition rate includes a recognition error rate of phonetic characters, and a recognition error rate of Chinese characters.

Furthermore the apparatus further includes a normalizing unit 85 configured to normalize the string of characters before the string of characters is divided.

Particularly the normalizing unit 85 is configured: to eliminate punctuations in the string of characters; for any one Chinese character in the string of characters, if the any one Chinese character represents a digit, to convert the any one Chinese character into a corresponding ASCII code character; and to convert phonetic characters in the string of characters into corresponding ASCII code characters.

Optionally the string of characters further includes a specific symbol; and the normalizing unit 85 is further configured: if the specific character is adjacent to a Chinese character, or the specific symbol is located between a Chinese character and a phonetic character, to delete the specific symbol; or if the specific symbol is located between phonetic characters, or the specific symbol is located between a phonetic character and a digit, to reserve the specific symbol, where the specific symbol is the Space symbol or the Tab symbol.

Optionally the sequence generating unit 81 is configured: for any one character in the string of characters, if the character type of the any one character is the Chinese character type, to determine the any one character as a recognition element; and if the any one character is a phonetic character, then if the any one character is not a first character in the string of characters, and the any one character is located between two Space symbols, or the any one character is the first character in the string of characters, and a next position to the any one character is the Space symbol to determine the any one character as a recognition element, otherwise, to locate the closest two Space symbols to the any one character respectively, and to determine all the characters between the located two Space symbols as a recognition element; to sort the respective determined recognition elements according to the positions of the determined recognition elements in the string of characters; and to determine the sorted recognition elements as the sequence of characters.

Optionally the calculating unit 82 is configured: to create a two-dimension grid, where a first dimension of the two-dimension grid represents the recognition elements in the sequence of characters, and a second dimension of the two-dimension grid represents the standard elements in the standard recognition result sequence; to count the number of instances of each error type corresponding to each grid element in the two-dimension grid respectively in the left to right direction and the top to bottom direction in the two-dimension grid, where the number of instances of the each error type is the sum of the number of instances of the error type in a preceding grid element corresponding to the error type, and the number of instances of the error type of the recognition element corresponding to the grid element with respect to the standard/ element, and the preceding grid element is a grid element, adjacent to the current grid element, to which a backtracking pointer corresponding to the error type points; to add the counted number of instances of each error type corresponding to each grid element in the two-dimension grid to the corresponding grid element; to select a grid element in the fast row and the last column in the two-dimension network, and to determine such one of the respective error types corresponding to the selected grid element that has the smallest number of instances; and to determine the number of instances of the determined error type as the shortest edition distance between the sequence of characters and the standard recognition result sequence.

Optionally the optimum alignment result determining unit 83 is configured; for each grid element in the two-dimension grid the operations of: determining such one of the respective error types corresponding to the grid element that has the smallest number of instances; determining the number of instances of the determined error type as the smallest number of error instances corresponding to the grid element; obtaining the backtracking pointer corresponding to the determined error type; determining a set of alignment relationships between the respective recognition elements corresponding to the sequence of characters, and the respective standard elements corresponding to the standard recognition result according to the pointing direction of the backtracking pointer obtained in each grid element starting from the grid element corresponding to the shortest edition distance in the two-dimension grid; and to determine the determined set of alignment relationships between the respective recognition elements corresponding to the sequence of characters, and the respective standard elements corresponding to the standard recognition result as the optimum alignment result between the sequence of characters and the standard recognition result sequence.

Optionally the recognition rate determining unit 84 is configured: to obtain an error type corresponding to each alignment relationship in the set of alignment relationships, and the number of instances of the error type; and to determine the recognition rate of the sequence of characters with respect to the standard recognition result sequence according to the number of instances of the error type corresponding to each alignment relationship in the set of alignment relationships.

Optionally the recognition rate determining unit 84 configured to determine the recognition rate of the sequence of characters with respect to the standard recognition result sequence according to the number of instances of the error type corresponding to each alignment relationship in the set of alignment relationships is configured: to select a correspondence relationship of Chinese characters in the set of alignment relationships, where the correspondence relationship of Chinese characters includes standard elements of Chinese characters, and to calculate the rate of the number of correspondence relationships of all the recognition errors in the selected correspondence relationship to the total number of standard elements of Chinese characters as the recognition error rate of Chinese characters of the sequence of characters with respect to the standard recognition result sequence; and to select a correspondence relationship of phonetic characters in the set of alignment relationships, where the correspondence relationship of phonetic characters includes standard elements of phonetic characters, and to calculate the rate of the number of error types of correspondence relationships of all the recognition errors in the selected correspondence relationship to the total number of standard elements of phonetic characters as the recognition error rate of phonetic characters of the sequence of characters with respect to the standard recognition result sequence.

Optionally the recognition rate further includes a rate of error type; and the recognition rate determining unit 84 configured to determine the recognition rate of the sequence of characters with respect to the standard recognition result sequence according to the number of instances of the error type corresponding to each alignment relationship in the set of alignment relationships is further configured to perform for each error type in the set of alignment relationships the following operations of: counting the total number of instances of the error type in the set of alignment relationships; counting the total number of instances of the respective error types in the set of correspondence relationships: and calculating the rate of the total number of instances of the error type to the total number of instances of the respective error types as the rate of error type for the error type.

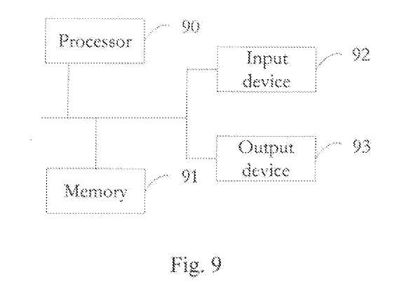

As shown in FIG. 9, some embodiments of the disclosure provide an electronic device including one or more processors 90 and a memory 91. FIG. 9 takes an example of one processor 90.

The electronic device further includes an input device 92 and an output device 93.

The processor 90 and the memory 91 can be connected together by a bus of other connections. The FIG. 9 takes an example of bus connection.

The memory 91 serves as a non-transitory computer-readable storage medium for storing non-transitory programs, non-transitory computer-executable instructions and modules, such as some modules for performing the method for determining recognition rate according to some embodiments of the disclosure (e.g. units as shown in FIG. 8). The processor 90 performs the method for determining recognition rate according to some embodiments of the disclosure by executing the non-transitory programs, instructions and modules.

The memory 91 can have a program-storing partition and a data-storing partition. Here the program-storing partition can store operation systems, at least one application for performing a certain function. The data-storing partition can store data generated by operation of the electronic device. Further, the memory 91 can be high-speed RAM, and also non-transitory memory, such as at least one magnetic disk memory device, flash memory or any other non-transitory solid memory device. In some embodiments, the memory 91 can be a remote memory which is arranged in a manner that is away from the processor 91. The remote memories can connected to the electronic device via network, of which instances include but not limit to internet, intranet, LAN, mobile radio communications and combination thereof.

The input device 92 can receive inputted digital or character information, and generate signal inputs concerning user setup and function control of the electronic device. The output device 93 can be display screen and other display devices.

At least one of the modules is stored in the memory 91. When at least one of the modules is executed by the at least one processor 90, it performs the aforementioned method for determining recognition rate.

The aforementioned electronic device can execute the method according to some embodiments of the disclosure, and has functional modules for executing corresponding method and advantageous thereof. For more technical details, the method according to some embodiments of the disclosure can be referred.

The electronic device according to some embodiments of the disclosure are in multiple forms, which include but not limit to:

1. Mobile communication device, of which characteristic has mobile communication function, and briefly acts to provide voice and data communication. These terminals include smart pone (i.e. iPhone), multimedia mobile phone, feature phone, cheap phone and etc.

2. Ultra mobile personal computing device, which belongs to personal computer, and has function of calculation and process, and has mobile networking function in general. These terminals include PDA, MID, UMPC (Ultra Mobile Personal Computer) and etc.

3. Portable entertainment equipment, which can display and play multimedia contents. These equipments include audio player, video player (e.g. iPod), handheld game player, electronic book, hobby robot and portable vehicle navigation device,

4. Server, which provides computing services, and includes processor, hard disk, memory, system bus and etc. The framework of the server is similar to the framework of universal computer, however, there is a higher requirement for processing capacity, stability, reliability, safety, expandability, manageability and etc due to supply of high reliability services.

5. Other, electronic devices having data interaction function.

Some embodiments of the disclosure provide a non-transitory computer-readable storage medium storing executable instructions that, when executed by an electronic device, cause the electronic device to perform the method for determining recognition rate according to any aforementioned embodiment.

In summary, a method and apparatus for determining a recognition rate according to some embodiments of the disclosure can obtain a string of characters obtained by recognizing voice, and a standard recognition result corresponding to the string of characters, where the standard recognition result includes characters of the phonetic character type, and characters of the Chinese character type; divide the string of characters according to a character type in the string of characters to generate a sequence of characters, where if the string of characters includes phonetic character, then a number of phonetic characters representing complete meaning will be divided into a recognition element, and divide the standard recognition result according to a character type in the standard recognition result to generate a standard recognition result sequence; calculate the shortest edition distance between the sequence of characters, and the standard recognition result sequence; obtain an optimum alignment result between the sequence of characters and the standard recognition result sequence according to the calculated shortest edition distance; and determine a recognition rate of the sequence of characters with respect to the standard recognition result sequence according to the optimum alignment result between the sequence of characters and the standard recognition result sequence, where the recognition rate includes a recognition rate of phonetic characters, and a recognition rate of Chinese characters. With the technical solutions according to the embodiments of the disclosure, the Chinese characters (and digits), and the phonetic words in the string of characters and the standard recognition result obtained as a result of recognition are determined as evaluation elements, the shortest edition distance is calculated, and the optimum set of alignment correspondence relationships for the string of characters and the standard recognition result is generated through backtracking, so that the error rate of Chinese characters and digits, the error rate of phonetic characters, and the total error rate can be calculated respectively, where a phonetic word can be treated as a whole to thereby avoid the error rate from being calculated incorrectly at a higher probability if each character in the word is regarded as an element, thus improving the accuracy of the calculated error rate.

The embodiments of the apparatus described above are merely exemplary, where the units described as separate components may or may not be physically separate, and the components Illustrated as elements may or may not he physical units, that is, they can be collocated or can be distributed onto a number of network elements. A part or all of the modules can be selected as needed in reality for the purpose of the solution according to the embodiments of the disclosure. This can be understood and practiced by those ordinarily skilled in the art without any inventive effort.

Those ordinarily skilled in the art can appreciate that all or a part of the steps in the methods according to the embodiments described above can be performed by program instructing relevant hardware, where the programs can be stored in a computer readable storage medium, and the programs can perform one or a combination of the steps in the embodiments of the method upon being executed: and the storage medium includes an ROM, an RAM, a magnetic disc, an optical disk, or any other medium which can store program codes.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. A method for determining a recognition rate, applicable to a terminal, comprising:
obtaining a string of characters obtained by recognizing voice, and a standard recognition result corresponding to the string of characters, wherein the standard recognition result comprises characters of phonetic character type, and characters of Chinese character type;
dividing the string of characters according to a character type in the string of characters to generate a sequence of characters, wherein when the string of characters comprises phonetic character, a number of phonetic characters representing one complete meaning is divided into a recognition element;
calculating a shortest edition distance between the sequence of characters, and a standard recognition result sequence generated by dividing the standard recognition result sequence;
obtaining an optimum alignment result between the sequence of characters and the standard recognition result sequence according to a calculated shortest edition distance; and
determining a recognition rate of the sequence of characters with respect to the standard recognition result sequence according to the optimum alignment result between the sequence of charactes and the standard recognition result sequence, wherein the recognition rate comprises a recognition error rate of phonetic characters, and a recognition error rate of Chinese characters.

2. The method according to claim 1, wherein dividing the string of characters to according to the character type in the string of characters generate the sequence of characters comprises:
for any one character in the string of characters, when the character type of the any one character is the Chinese character type, determining the any one character as a recognition element; and when the any one character is a phonetic character, if the any one character is not a first character in the string of characters, and the any one character is located between two Space symbols, or the any one character is the first character in the string of characters, and a next position to the any one character is the Space symbol, then determining the any one character as a recognition element, otherwise, locating the closest two Space symbols to the any one character respectively, and determining all the characters between the located two Space symbols as a recognition element;
sorting respective determined recognition elements according to the positions of the determined recognition elements in the string of characters; and
determining sorted recognition elements as the sequence of characters.

3. The method according to claim 2, wherein calculating the shortest edition distance between the sequence of characters, and the standard recognition result sequence comprises:
creating a two-dimension grid, wherein a first dimension of the two-dimension grid represents the recognition elements in the sequence of characters, and a second dimension of the two-dimension grid represents the standard elements in the standard recognition result sequence;
counting the number of instances of each error type corresponding to each grid element in the two-dimension grid respectively in the left to right direction and the top to bottom direction in the two-dimension grid, wherein the number of instances of the each error type is a sum of the number of instances of the error type in a preceding grid element corresponding to the error type, and the number of instances of the error type of the recognition element corresponding to the grid element with respect to the standard element, and the preceding grid element is a grid element, adjacent to a current grid element, to which a backtracking pointer corresponding to the error type points;
adding counted number of instances of each error type corresponding to each grid element in the two-dimension grid to the corresponding grid element;
selecting a grid element in last row and last column in the two-dimension network, and determining such one of respective error types corresponding to selected grid element that has the smallest number of instances; and
determining the number of instances of the determined error type as the shortest edition distance between the sequence of characters and the standard recognition result sequence.

4. The method according to claim 3, wherein obtaining the optimum alignment result between the sequence of characters and the standard recognition result sequence comprises:
for each grid element in the two-dimension grid, performing the operations of:
determining such one of the respective error types corresponding to the grid element that has the smallest number of instances; determining the number of instances of the determined error type as the smallest number of error instances corresponding to the grid element; and obtaining the backtracking pointer corresponding to the determined error type;
determining a set of alignment relationships between the respective recognition elements corresponding to the sequence of characters, and the respective standard elements corresponding to the standard recognition result according to the pointing direction of the backtracking pointer obtained in each grid element starting from the grid element corresponding to the shortest edition distance in the two-dimension grid; and
determining the determined set of alignment relationships between the respective recognition elements corresponding to the sequence of characters, and the respective standard elements corresponding to the standard recognition result as the optimum alignment result between the sequence of characters and the standard recognition result sequence.

5. The method according to claim 4, wherein determining the recognition rate of the sequence of characters with respect to the standard recognition result sequence according to the optimum alignment result between the sequence of characters and the standard recognition result sequence comprises:
obtaining an error type corresponding to each alignment relationship in the set of alignment relationships, and the number of instances of the error type; and
determining the recognition rate of the sequence of characters with respect to the standard recognition result sequence according to the number of instances of the error type corresponding to each alignment relationship in the set of alignment relationships.

6. The method according to claim 5, wherein determining the recognition rate of the sequence of characters with respect to the standard recognition result sequence according to the number of instances of the error type corresponding to each alignment relationship in the set of alignment relationships comprises:
selecting a correspondence relationship of Chinese characters in the set of alignment relationships, wherein the correspondence relationship of Chinese characters comprises standard elements of Chinese characters: and calculating a rate of the number of correspondence relationships of all the recognition errors in the selected correspondence relationship to the total number of standard elements of Chinese characters as the recognition error rate of Chinese characters of the sequence of characters with respect to the standard recognition result sequence; and
selecting a correspondence relatioship of phonetic characters in the set of alignment relationships, wherein the correspondence relationship of phonetic characters comprises standard elements of phonetc characters; and calculating a rate of the number of error types of correspondence relationships of all the recognition errors in the selected correspondence relationship to the total number of standard elements of phonetic characters as the recognition error rate of phonetic characters of the sequence of characters with respect to the standard recognition result sequence.

7. An electronic device, comprising:
at least one processor; and
a memory communicably connected with the at least one processor for storing instructions executable by the at least one processor, wherein execution of the instructions by the at least one processor causes the at least one processor to:
obtain a string of characters obtained by recognizing voice, and a standard recognition result corresponding to the string of characters, wherein the standard recognition result comprises characters of phonetic character type, and characters of Chinese character type;
divide the string of characters according to a character type in the string of characters to generate a sequence of characters, wherein when the string of Characters comprises phonetic character, a number of phonetic characters representing one complete meaning is divided into a recognition element;
calculate a shortest edition distance between the sequence of characters, and a standard recognition result sequence generated by dividing the standard recognition result;
obtain an optimum alignment result between the sequence of characters and the standard recognition result sequence according to the calculated shortest edition distance; and
determine a recognition rate of the sequence of characters with respect to the standard recognition result sequence according to the optimum alignment result between the sequence of characters and the standard recognition result sequence, wherein the recognition rate comprises a recognition error rate of phonetic characters, and a recognition error rate of Chinese characters.

8. The electronic device according to claim 1, wherein the divide the string of characters according to a character type in the string of characters to generate a sequence of characters comprises:
for any one character in the string of characters, when the character type of the any one character is the Chinese character type, determine the any one character as a recognition element; and when the any one character is a phonetic character, if the any one character is not a first character in the string of characters, and the any one character is located between two Space symbols, or the any one character is the first character in the string of characters, and a next position to the any one character is the Space symbol, determine the any one character as a recognition element, otherwise, locate the closest two Space symbols to the any one character respectively, and determine all the characters between the located two Space symbols as a recognition element;
sort the respective determined recognition elements according to the positions of the determined recognition elements in the string of characters; and
determine the sorted recognition elements as the sequence of characters.

9. The electronic device according to claim 8, wherein the calculate a shortest edition distance between the sequence of characters, and a standard recognition result sequence generated by dividing the standard recognition result comprises:
create a two-dimension grid, wherein a first dimension of the two-dimension grid represents the recognition elements in the sequence of characters, and a second dimension of the two-dimension grid represents the standard elements in the standard recognition result sequence;
count the number of instances of each error type corresponding to each grid element in the two-dimension grid respectively in the left to right direction and the top to bottom direction in the two-dimension grid, wherein the number of instances of the each error type is a sum of the number of instances of the error type in a preceding grid element corresponding to the error type, and the number of instances of the error type of the recognition element corresponding to the grid element with respect to the standard element, and the preceding grid element is a grid element, adjacent to a current grid element to which a backtracking pointer corresponding to the error type points;
add counted number of instances of each error type corresponding to each grid element in the two-dimension grid to the corresponding grid element;
select a grid element in a last row and a last column in the two-dimension network, and determine such one of the respective error types corresponding to the selected grid element that has the smallest number of instances; and
determine the number of instances of the determined error type as the shortest edition distance between the sequence of characters and the standard recognition result sequence.

10. The electronic device according to claim 9, wherein the obtain an optimum alignment result between the sequence of characters and the standard recognition result sequence according to the calculated shortest edition distance comprises:
for each grid element in the two-dimension grid, perform the operations of:
determining such one of the respective error types corresponding to the grid element that has the smallest number of instances; determining the number of instances of the determined error type as the smallest number of error instances corresponding to the grid element; and obtaining the backtracking pointer corresponding to the determined error type;
determining a set of alignment, relationships between the respective recognition elements corresponding to the sequence of characters, and the respective standard elements corresponding to the standard recognition result according to the pointing direction of the backtracking pointer obtained in each grid element starting from the grid element corresponding to the shortest edition distance in the two-dimension grid; and
determining the determined set of alignment relationships between the respective recognition elements corresponding to the sequence of characters, and the respective standard elements corresponding to the standard recognition result as the optimum alignment result between the sequence of characters and the standard recognition result sequence.

11. The electronic device according to claim 10, wherein the determine a recognition, rate of the sequence of characters with respect to the standard recognition result sequence according to the optimum alignment result between the sequence of characters and the standard recognition result sequence comprises:
obtain an error type corresponding to each alignment relationship in the set of alignment relationships, and the number of instances of the error type; and
determine the recognition rate of the sequence of characters with respect to the standard recognition result sequence according to the number of instances of the error type corresponding to each alignment relationship in the set of alignment relationships.

12. The electronic device according to claim 11, wherein the determine the recognition rate of the sequence of characters with respect to the standard recognition result sequence according to the number of instances of the error type corresponding to each alignment relationship in the set of alignment relationships comprises:
select a correspondence relationship of Chinese characters in the set of alignment relationships, wherein the correspondence relationship of Chinese characters comprises standard elements of Chinese characters; and calculate a rate of the number of correspondence relationships of all the recognition errors in the selected correspondence relationship to the total number of standard elements of Chinese characters as the recognition error rate of Chinese characters of the sequence of characters with respect to the standard recognition result sequence; and
select a correspondence relationship of phonetic characters in the set of alignment relationships, wherein the correspondence relationship of phonetic characters comprises standard elements of phonetic characters; and calculate a rate of the number of error types of correspondence relationships of all the recognition, errors in the selected correspondence relationship to the total number of standard elements of phonetic characters as the recognition error rate of phonetic characters of the sequence of characters with respect to the standard recognition result sequence.

13. A non-transitory computer-readable storage medium storing executable instructions that, when executed by an electronic device, cause the electronic device to:
obtain a string of characters obtained by recognizing voice, and a standard recognition result corresponding to the string of characters, wherein the standard recognition result comprises characters of phonetic character type, and characters of Chinese character type;
divide the string of characters according to a character type in the string of characters to generate a sequence of characters, wherein when the string of characters comprises phonetic character, a number of phonetic characters representing one complete meaning is divided into a recognition element;
calculate a shortest edition distance between the sequence of characters, and a standard recognition result sequence generated by dividing the standard recognition result;
obtain an optimum alignment result between the sequence of characters and the standard recognition result sequence according to the calculated shortest edition distance; and
determine a recognition rate of the sequence of characters with respect to the standard recognition result sequence according to the optimum alignment result between the sequence of characters and the standard recognition result sequence, wherein the recognition rate comprises a recognition error rate of phonetic characters, and a recognition error rate of Chinese characters.

14. The non-transitory computer-readable storage medium according to claim 13, wherein the divide the string of characters according to a. character type in the string of characters to generate a sequence of characters comprises:
for any one character In the string of characters, when the character type of the any one character is the Chinese character type, determine the any one character as a recognition element: and when the any one character is a phonetic character, if the any one character is not a first character In the string of characters, and the any one character is located between two Space symbols, or the any one character is the first character in the string of characters, and a next position, to the any one character is the Space symbol, determine the any one character as a recognition element, otherwise, locate the closest two Space symbols to the any one character respectively, and determine all the characters between the located two Space symbols as a recognition demerit;
sort the respective determined recognition elements according to the positions of the determined recognition elements in the string of characters; and
determine the sorted recognition elements as the sequence of characters.

15. The non-transitory computer-readable storage medium according to claim 14, wherein the calculate a shortest edition distance between the sequence of characters, and a standard recognition result sequence generated by dividing the standard recognition result comprises:
create a two-dimension grid, wherein a first dimension of the two-dimension grid represents the recognition elements in the sequence of characters, and a second dimension of the two-dimension grid represents the standard elements in the standard recognition result sequence;
count the number of instances of each error type corresponding to each grid element in the two-dimension grid respectively in the left to right direction and the top to bottom direction in the two-dimension grid, wherein the number of instances of the each error type is a sum of the number of instances of the error type in a preceding grid element corresponding to the error type, and the number of instances of the error type of the recognition element corresponding to the grid element with respect to the standard element, and the preceding grid element is a grid element, adjacent to a current grid element, to which a backtracking pointer corresponding to the error type points;
add counted number of instances of each error type corresponding to each grid element in the two-dimension grid to the corresponding grid element;
select a grid element in a last row and a last column in the two-dimension network, and determine such one of the respective error types corresponding to the selected grid element that has the smallest number of instances; and
determine the number of instances of the determined error type as the shortest edition distance between the sequence of characters and the standard recognition result sequence.

16. The non-transitory computer-readable storage medium according to claim IS, wherein the obtain an optimum alignment result between the sequence of characters and the standard recognition result sequence according to the calculated shortest edition distance comprises:
for each grid element in the two-dimension grid, perform the operations of
determining such one of the respective error types corresponding to the grid element that, has the smallest number of instances; determining the number of instances of the determined
determining a set of alignment relationships between the respective recognition elements corresponding to the sequence of characters, and the respective standard elements corresponding to the standard recognition result according to the pointing direction of the backtracking pointer obtained in each grid element starting from the grid element corresponding to the shortest edition distance in the two-dimension grid; and
determining the determined set of alignment relationships between the respective recognition elements corresponding to the sequence of characters, and the respective standard elements corresponding to the standard recognition result as the optimum alignment result between the sequence of characters and the standard recognition result sequence,

17. The non-transitory computer-readable storage medium according to claim 16, wherein the determine a recognition rate of the sequence of characters with respect to the standard recognition result sequence according to the optimum alignment result between the sequence of characters and the standard recognition result sequence comprises:
obtain an error type corresponding to each alignment relationship in the set of alignment relationships, and the number of instances of the error type: and
determine the recognition rate of the sequence of characters with respect to the standard recognition result sequence according to the number of instances of the error type corresponding to each alignment relationship in the set of alignment relationships,

18. The non-transitory computer-readable storage medium according to claim 17, wherein the determine the recognition rate of the sequence of characters with respect to the standard recognition result sequence according to the number of instances of the error type corresponding to each alignment relationship in the set of alignment relationships comprises:
select a correspondence relationship of Chinese characters in the set of alignment relationships, wherein the correspondence relationship of Chinese characters comprises standard elements of Chinese characters; and calculate a rate of the number of correspondence relationships of all the recognition errors in the selected correspondence relationship to the total number of standard elements of Chinese characters as the recognition error rate of Chinese characters of the sequence, of characters with respect to the standard recognition result sequence; and
select a standard elements of phonetic characters, and calculate a rate of the number of error types of correspondence relationship of all the recognition errors in the select correspondence relationship to the total number of standard elements of phonetic characters as the recognition error rate of phonetic characters of the sequence of characters with respect to the standard recognition result sequence.
